(19) United States
(12) Patent Application Publication
(10) Pub. No.: US 2026/0031372 A1
(43) Pub. Date: Jan. 29, 2026

(54) ELECTRIC POWER SUPPLY SYSTEM

(71) Applicant: TATSUMI RYOKI CO., LTD, Tokyo (JP)

(72) Inventor: Toyoshi KONDO, Tokyo (JP)

(21) Appl. No.: 18/844,354

(22) PCT Filed: Mar. 30, 2022
(86) PCT No.: PCT/JP2022/015820

§ 371 Date: Mar. 6, 2025

(51) Int. Cl. H01M 8/04082; H01M 8/04014; H01M 8/04029; H01M 8/0444; H01M 8/04701; H01M 8/04746; H01M 8/0606

(52) U.S. Cl. CPC H01M 8/04216; H01M 8/04014; H01M 8/04029; H01M 8/0444; H01M 8/04738; H01M 8/04753; H01M 8/04776; H01M 8/0606

(57) ABSTRACT

Provided is an electric power supply system capable of efficiently storing and discharging hydrogen.

The electric power supply system includes a hydrogen storage unit, a holding unit including a first holding device that holds a first hydrogen tank, a second holding device that holds a second hydrogen tank, and a third holding device that holds a third hydrogen tank, and a fuel cell that generates electric power based on hydrogen supplied from the hydrogen storage unit. For a hydrogen tank that receives hydrogen supplied from the hydrogen generation unit, a valve between the hydrogen tank and the hydrogen generation unit is opened, and a valve between the hydrogen tank and the fuel cell is closed during the reception of supplied hydrogen. For a hydrogen tank that supplies hydrogen to the fuel cell, a valve between the hydrogen tank and the hydrogen generation unit is closed, and a valve between the hydrogen tank and the fuel cell is opened during the hydrogen supply. For a hydrogen tank that does not receive hydrogen supplied from the hydrogen generation unit and does not supply hydrogen to the fuel cell, a valve between the hydrogen tank and the hydrogen generation unit is closed, a valve between the hydrogen tank and the fuel cell is closed, and the hydrogen tank is removably held by the holding unit.

### TECHNICAL FIELD

The present invention relates to an electric power supply system and the like.

### BACKGROUND ART

Hitherto, there has been proposed a system that stores electric power and supplies the stored electric power to an electric vehicle or the like as in Patent Literature 1.

### CITATION LIST

### Patent Literature

Patent Literature 1: JP 2014-122399 A

### SUMMARY OF INVENTION

### Technical Problem

However, control of storage and discharge of hydrogen is not sufficiently considered.

In this regard, an object of the present invention is to provide an electric power supply system capable of efficiently storing and discharging hydrogen.

### Solution to Problem

An electric power supply system according to the present invention includes a hydrogen generation unit, a hydrogen storage unit including a first hydrogen tank, a second hydrogen tank, and a third hydrogen tank that store hydrogen obtained by the hydrogen generation unit, a holding unit including a first holding device that holds the first hydrogen tank, a second holding device that holds the second hydrogen tank, and a third holding device that holds the third hydrogen tank, and a fuel cell configured to generate electric power based on hydrogen supplied from the hydrogen storage unit.

Each of the first hydrogen tank, the second hydrogen tank, and the third hydrogen tank holds a hydrogen storage alloy therein and stores hydrogen by absorption.

For a hydrogen tank that receives hydrogen supplied from the hydrogen generation unit among the first hydrogen tank, the second hydrogen tank, and the third hydrogen tank, a valve between the hydrogen tank and the hydrogen generation unit is opened, and a valve between the hydrogen tank and the fuel cell is closed during the reception of supplied hydrogen.

For a hydrogen tank that supplies hydrogen to the fuel cell among the first hydrogen tank, the second hydrogen tank, and the third hydrogen tank, a valve between the hydrogen tank and the hydrogen generation unit is closed, and a valve between the hydrogen tank and the fuel cell is opened during the hydrogen supply.

For a hydrogen tank that does not receive hydrogen supplied from the hydrogen generation unit and does not supply hydrogen to the fuel cell among the first hydrogen tank, the second hydrogen tank, and the third hydrogen tank, a valve between the hydrogen tank and the hydrogen generation unit is closed, a valve between the hydrogen tank and the fuel cell is closed, and the hydrogen tank is removably held by the holding unit.

In the electric power supply system that generates electric power based on hydrogen, a hydrogen tank (for example, the first hydrogen tank) that stores hydrogen, a hydrogen tank (for example, the second hydrogen tank) that discharges hydrogen, and a hydrogen tank (for example, the third hydrogen tank) that is removably held by a holding device without performing hydrogen storage and hydrogen discharge are provided.

Therefore, it is possible to simultaneously perform hydrogen storage, hydrogen discharge, and hydrogen tank replacement in the hydrogen tanks, and it is possible to efficiently store and discharge hydrogen.

Preferably, the hydrogen storage unit includes a detection unit including a first detection device that includes a first transmission unit that emits radio waves having a first frequency and a first communication unit that receives the radio waves from the first transmission unit.

The first transmission unit and the first communication unit are disposed in a positional relationship in which the hydrogen storage alloy of the first hydrogen tank is sandwiched.

The electric power supply system includes a control unit configured to calculate a hydrogen filling rate of the first hydrogen tank based on information regarding at least one of a radio wave intensity or a signal waveform of the radio waves obtained from the first transmission unit by the first communication unit.

When the amount of hydrogen absorbed in the hydrogen storage alloy changes, the shape and the like of the hydrogen storage alloy change. Based on said change, the radio wave intensity that can be received through said hydrogen storage alloy changes. Therefore, by disposing a transmission unit and a communication unit (reception device) in a positional relationship in which said hydrogen storage alloy is sandwiched, it is possible to acquire information regarding the radio wave intensity that can be received through the hydrogen storage alloy, and it is possible to calculate the amount of hydrogen absorbed in said hydrogen storage alloy, that is, the hydrogen filling rate of the hydrogen tank containing said hydrogen storage alloy based on said information regarding the radio wave intensity.

Hydrogen can be efficiently stored and discharged by supplying hydrogen to the fuel cell for a hydrogen tank having a high hydrogen filling rate and receiving hydrogen supplied from the hydrogen generation unit for a hydrogen tank having a low hydrogen filling rate.

Preferably, the hydrogen storage unit includes a detection unit including a first detection device that includes a first transmission unit that emits radio waves having a first frequency and a first communication unit that receives the radio waves from the first transmission unit, and
the first transmission unit and the first communication unit are disposed in a positional relationship in which the hydrogen storage alloy of the first hydrogen tank is sandwiched.

The electric power supply system according to claim 1 includes a control unit configured to open a first inlet valve to supply hydrogen to the first hydrogen tank in a case where a hydrogen filling rate of the first hydrogen tank is lower than a hydrogen filling rate threshold, and close the first inlet valve in a case where the hydrogen filling rate of the first hydrogen tank is equal to or higher than the hydrogen filling rate threshold, based on information regarding at least one of a radio wave intensity or a signal waveform of the radio waves obtained from the first transmission unit by the first communication unit.

More preferably, the first hydrogen tank is made of a resin having radio wave permeability.

The first transmission unit and the first communication unit are attached to an outer wall of the first hydrogen tank.

Preferably, the electric power supply system includes a heat transfer unit including a fan configured to supply cooling air to the fuel cell, and a guide path configured to guide hot air obtained by heating the cooling air by the fuel cell to the first hydrogen tank to the third tank.

The electric power supply system includes a control unit configured to control a valve of the guide path in such a way that the hot air is supplied to the hydrogen tank that supplies hydrogen to the fuel cell among the first hydrogen tank, the second hydrogen tank, and the third hydrogen tank, via the guide path.

### (Effect of Transferring Heat to Hydrogen Tank)

By transferring heat obtained by the fuel cell to a hydrogen tank, the hydrogen storage alloy can be heated, and hydrogen can be easily released from said hydrogen storage alloy.

Preferably, the electric power supply system includes a water heater configured to heat cold water.

The electric power supply system includes a hot water pipe configured to supply hot water from the water heater to the first holding device, the second holding device, and the third holding device.

The electric power supply system includes a heat transfer unit including a fan configured to supply cooling air to the fuel cell, and a guide path configured to guide hot air obtained by heating the cooling air by the fuel cell to at least one of the water heater or the hot water pipe.

### (Effect of Transferring Heat to Water Heater or the Like)

By transferring heat obtained by the fuel cell to the water heater or the like, the hydrogen storage alloy can be heated, and hydrogen can be easily released from said hydrogen storage alloy.

Preferably, the hydrogen tank that receives hydrogen supplied from the hydrogen generation unit among the first hydrogen tank, the second hydrogen tank, and the third hydrogen tank is unremovably held by the holding unit during the reception of supplied hydrogen.

The hydrogen tank that supplies hydrogen to the fuel cell among the first hydrogen tank, the second hydrogen tank, and the third hydrogen tank is unremovably held by the holding unit during the hydrogen supply.

More preferably, the first holding device includes a first locking mechanism that brings the first hydrogen tank into a removable state when in an on state and brings the first hydrogen tank into an unremovable state when in an off state.

The first locking mechanism is turned on when both a valve between the hydrogen generation unit and the first hydrogen tank and a valve between the fuel cell and the first hydrogen tank are closed.

### (Effect of Providing Locking Mechanism)

It is possible to prevent the hydrogen tank from being inadvertently detached from a holding mechanism even when electric power supply is interrupted and the first locking mechanism is turned off.

In addition, said hydrogen tank is brought into a removable state on the condition that both an inlet valve and an outlet valve of said hydrogen tank are closed. Therefore, it is possible to prevent the hydrogen tank from being inadvertently detached from the holding mechanism during filling of hydrogen or discharge of hydrogen.

Preferably, the electric power supply system includes a heat transfer unit configured to transfer heat generated by the fuel cell to the hydrogen tank that supplies to the fuel cell among the first hydrogen tank, the second hydrogen tank, and the third hydrogen tank.

### Advantageous Effects of Invention

As described above, according to the present invention, it is possible to provide an electric power supply system capable of efficiently storing and discharging hydrogen.

### BRIEF DESCRIPTION OF DRAWINGS

FIG. 1 is a configuration diagram of an electric power supply system according to the present embodiment.

FIG. 2 is a diagram illustrating a flow of waste heat from a second DC power generation device.

### DESCRIPTION OF EMBODIMENTS

Hereinafter, the present embodiment will be described with reference to the drawings.

Note that the embodiment is not limited to the following embodiment. In addition, the contents described in one embodiment are similarly applied to other embodiments in principle. Further, each embodiment and each modification can be appropriately combined.

### (Electric Power Supply System 1)

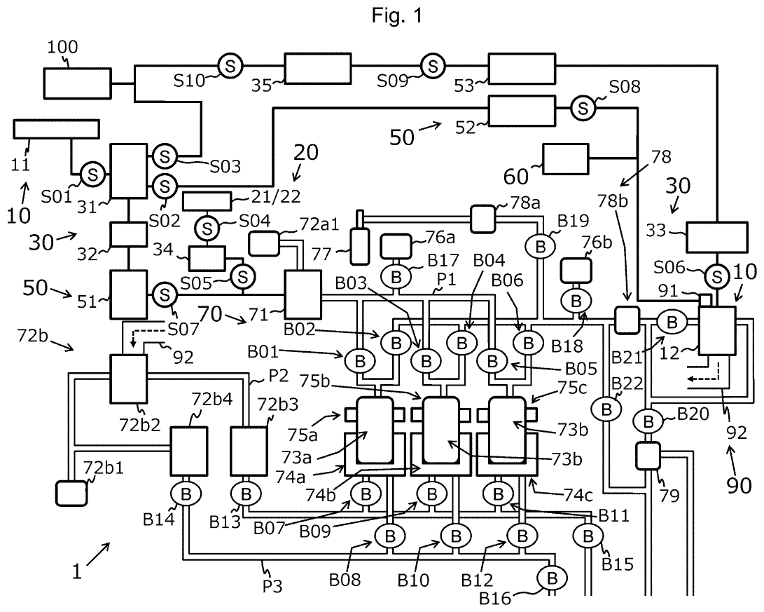

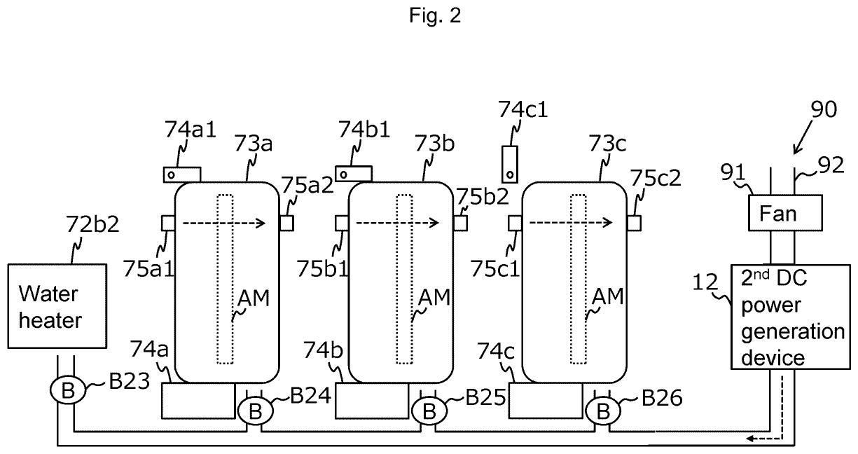

An electric power supply system 1 of the present embodiment includes a direct current (DC) power supply unit 10, an alternating current (AC) power supply unit 20, a conversion unit 30, an electric power storage unit 50, a control unit 60, a hydrogen supply unit 70, a heat transfer unit 90, switches (01-th to 10-th switches S01 to S10), and valves (01-th to 26-th valves B01 to B26) (see FIGS. 1 and 2).

In FIG. 1, illustration of a locking mechanism (such as a first locking mechanism 74a1) of the hydrogen supply unit 70 and a part of a guide path 92 of the heat transfer unit 90 is omitted.

In addition, in FIG. 2, a hydrogen storage alloy AM that is invisible from the outside is indicated by a dotted line.

The electric power supply system 1 generates electric power and supplies the generated electric power to an external load.

In addition, the electric power supply system 1 generates hydrogen and generates the electric power based on the generated hydrogen.

The generated electric power is supplied to a load 100.

The load 100 is an electric device driven by AC power, such as an air conditioner.

### (DC Power Supply Unit 10)

The DC power supply unit 10 includes a first DC power generation device 11 and a second DC power generation device 12.

### (First DC Power Generation Device 11)

The first DC power generation device 11 is an electric power generation device (renewable energy-derived electric power generation device) that generates direct current (DC) power based on natural energy (renewable energy), such as a solar electric power generation device.

The first DC power generation device 11 is always in a state where electric power generation can be performed.

The electric power obtained by the first DC power generation device 11 is supplied to a first electric power storage device 51 of the electric power storage unit 50 via a first conversion device 31 and a second conversion device 32 of the conversion unit 30.

The electric power obtained by the first DC power generation device 11 is supplied to a second electric power storage device 52 of the electric power storage unit 50 via the first conversion device 31 of the conversion unit 30.

The electric power obtained by the first DC power generation device 11 is supplied to the load 100 via the first conversion device 31 of the conversion unit 30.

The first DC power generation device 11 includes a backflow prevention device such as a diode.

In the present embodiment, an example in which the electric power obtained by the first DC power generation device 11 is supplied to a hydrogen generation unit 71 via the first electric power storage device 51 will be described.

However, the electric power obtained by the first DC power generation device 11 may be directly supplied to the hydrogen generation unit 71 without passing through the first electric power storage device 51.

### (Second DC Power Generation Device 12)

The second DC power generation device 12 is an electric power generation device (fuel cell) that generates electric power based on hydrogen.

The second DC power generation device 12 is brought into a state where electric power generation can be performed in a case where the electric power supplied from the first DC power generation device 11 or the like is not sufficient.

The electric power obtained by the second DC power generation device 12 is supplied to a third electric power storage device 53 of the electric power storage unit 50 via a third conversion device 33 of the conversion unit 30.

The second DC power generation device 12 includes a backflow prevention device such as a diode.

### (AC Power Supply Unit 20)

The AC power supply unit 20 includes a first AC power generation device 21.

### (First AC Power Generation Device 21)

The first AC power generation device 21 is an electric power generation device (renewable energy-derived electric power generation device) that generates alternating current (AC) power based on natural energy (renewable energy), such as a wind power generation device or a wave power generation device.

The first AC power generation device 21 is always in a state where electric power generation can be performed.

However, in a case where the first AC power generation device 21 is a wind power generation device, and wind power received by the first AC power generation device 21 exceeds predetermined wind power, the first AC power generation device 21 is brought into a state where electric power generation cannot be performed.

The electric power obtained by the first AC power generation device 21 is supplied to the hydrogen generation unit 71 of the hydrogen supply unit 70 via a fourth conversion device 34 of the conversion unit 30.

### (Second AC Power Generation Device 22)

The AC power supply unit 20 may include a second AC power generation device 22 instead of the first AC power generation device 21 or in addition to the first AC power generation device 21.

The second AC power generation device 22 is an electric power generation device that generates AC power based on kinetic energy obtained by an internal combustion engine or an external combustion engine, such as an LP gas power generation device.

In the present embodiment, an example in which the electric power obtained by the AC power supply unit 20 is supplied to the hydrogen generation unit 71 will be described.

However, the electric power obtained by the AC power supply unit 20 may be supplied to the first electric power storage device 51, the second electric power storage device 52, the load 100, and the like.

### (Conversion Unit 30)

The conversion unit 30 includes the first conversion device 31 to a fifth conversion device 35.

### (First Conversion Device 31)

The first conversion device 31 includes a DC/AC inverter.

An input side of the first conversion device 31 is connected to the first DC power generation device 11 via the 01-th switch S01.

An output side of the first conversion device 31 is connected to the second conversion device 32, is connected to the second electric power storage device 52 via the 02-th switch S02, and is connected to the load 100 via the 03-th switch S03.

The first conversion device 31 converts a flow of electricity of the electric power obtained by the first DC power generation device 11 from direct current to alternating current.

### (Second Conversion Device 32)

The second conversion device 32 includes an AC/DC converter.

An input side of the second conversion device 32 is connected to the first conversion device 31.

An output side of the second conversion device 32 is connected to the first electric power storage device 51.

The second conversion device 32 converts a flow of electricity of the electric power from the first conversion device 31 from alternating current to direct current.

### (Third Conversion Device 33)

The third conversion device 33 includes a DC/DC converter.

An input side of the third conversion device 33 is connected to the second DC power generation device 12 via the 06-th switch S06.

An output side of the third conversion device 33 is connected to the third electric power storage device 53.

The third conversion device 33 converts the electric power obtained by the second DC power generation device 12 into a predetermined voltage and a predetermined current.

### (Fourth Conversion Device 34)

The fourth conversion device 34 includes an AC/DC converter.

An input side of the fourth conversion device 34 is connected to the first AC power generation device 21 via the 04-th switch S04.

An output side of the fourth conversion device 34 is connected to the hydrogen generation unit 71 via the 05-th switch S05.

The fourth conversion device 34 converts a flow of electricity of the electric power from the first AC power generation device 21 from alternating current to direct current.

(Fifth Conversion Device 35) The fifth conversion device 35 includes a DC/AC inverter.

An input side of the fifth conversion device 35 is connected to the third electric power storage device 53 via the 09-th switch S09.

An output side of the fifth conversion device 35 is connected to the load 100 via the 10-th switch S10.

The fifth conversion device 35 converts a flow of electricity of the electric power stored in the third electric power storage device 53 from direct current to alternating current.

### (Electric Power Storage Unit 50)

The electric power storage unit 50 includes the first to third electric power storage devices 51 to 53.

The electric power stored in the first electric power storage device 51 is mainly used for generating hydrogen, that is, for driving the hydrogen generation unit 71.

The electric power stored in the second electric power storage device 52 is mainly used to drive each unit of the electric power supply system 1.

The electric power stored in the third electric power storage device 53 is mainly used for driving the load 100.

### (First Electric Power Storage Device 51)

The first electric power storage device 51 includes a charge device and an electric power storage device for storing electric power from the first DC power generation device 11.

The electric power stored in the first electric power storage device 51 is supplied to the hydrogen generation unit 71.

That is, the electric power stored in the first electric power storage device 51 is used for electrolysis of water.

### (Second Electric Power Storage Device 52)

The second electric power storage device 52 includes a charge device and an electric power storage device for storing electric power from the first DC power generation device 11.

The electric power stored in the second electric power storage device 52 is supplied to each unit (the control unit 60, a fan 91, switches, valves, and the like) of the electric power supply system 1.

### (Third Electric Power Storage Device 53)

The third electric power storage device 53 includes a charge device and an electric power storage device for storing electric power from the second DC power generation device 12.

The electric power stored in the third electric power storage device 53 is supplied to the load 100.

### (Control Unit 60)

The control unit 60 controls each unit of the electric power supply system 1.

Specifically, the control unit 60 performs on/off control of the 01-th to 10-th switches S01 to S10, open/close control of the 01-th to 26-th valves B01 to B26, on/off control of the first to third locking mechanisms 74a1 to 74c1, and the like according to a state of each unit of the electric power supply system 1.

The control unit 60 drives the fan 91 while the second DC power generation device 12 is generating the electric power, and the fan 91 sends cooling air to the second DC power generation device 12. Said cooling air is heated by the second DC power generation device 12, and the hot air is supplied to a water heater 72b2, a hydrogen tank that discharges hydrogen in a hydrogen storage unit 73, and the like.

### (Valve Control)

When filling the hydrogen tank with hydrogen, the control unit 60 opens an inlet valve of said hydrogen tank and closes an outlet valve. In addition, the control unit 60 opens a cold water supply valve of said hydrogen tank and closes a hot water supply valve of a holding device of said hydrogen tank. In addition, the control unit 60 turns off a locking mechanism of the holding device that holds said hydrogen tank so that said hydrogen tank cannot be removed from said holding device.

When discharging hydrogen from the hydrogen tank, the control unit 60 closes the inlet valve of said hydrogen tank and opens the outlet valve. In addition, the control unit 60 closes the cold water supply valve of said hydrogen tank and opens the hot water supply valve of the holding device of said hydrogen tank. In addition, the control unit 60 turns off a locking mechanism of the holding device that holds said hydrogen tank so that said hydrogen tank cannot be removed from said holding device.

In a case where the hydrogen tank is detachably held, the control unit 60 closes the inlet valve and the outlet valve of said hydrogen tank. In addition, the control unit 60 closes the cold water supply valve and the hot water supply valve of the holding device of said hydrogen tank. In addition, the control unit 60 turns on the locking mechanism of the holding device that holds said hydrogen tank so that said hydrogen tank can be removed from said holding device.

The control unit 60 determines whether or not a hydrogen filling rate rh of the hydrogen tank being filled with hydrogen is equal to or higher than a hydrogen filling rate threshold thrh based on information from a detection unit 75 of the hydrogen supply unit 70.

In a case where the hydrogen filling rate rh is equal to or higher than the hydrogen filling rate threshold thrh, the control unit 60 closes the valve to stop supply of hydrogen to said hydrogen tank. In addition, the control unit 60 closes the valve to stop supply of the cooling water to said hydrogen tank.

The control unit 60 or a recording device (not illustrated) records a database indicating a relationship among a radio wave intensity, the amount of hydrogen stored in the hydrogen storage alloy AM, and the hydrogen filling rate rh of the hydrogen tank. The control unit 60 calculates the hydrogen filling rate rh for each hydrogen tank based on information regarding the radio wave intensity from a first communication unit 75a2 of the detection unit 75 and the like and said database.

The hydrogen filling rate rh is defined as a ratio of a storage amount (cc/g or wt %) of hydrogen (absorbed by the hydrogen storage alloy) filled in the hydrogen tank and the maximum storage amount of hydrogen that can be filled in said hydrogen tank.

The control unit 60 controls a valve of the guide path in such a way that the hot air is supplied to one of a first hydrogen tank 73a, a second hydrogen tank 73b, and a third hydrogen tank 73c that supplies hydrogen to the second DC power generation device 12 via the guide path 92.

The control unit 60 controls the valve of the guide path in such a way that the hot air is not supplied via the guide path 92 to a hydrogen tank that receives hydrogen supplied from the hydrogen generation unit 71 and a hydrogen tank removably held by the holding device among the first hydrogen tank 73a, the second hydrogen tank 73b, and the third hydrogen tank 73c.

For example, valve opening/closing control in a case where the first hydrogen tank 73a of the hydrogen storage unit 73 is filled with hydrogen, hydrogen is discharged from the second hydrogen tank 73b of the hydrogen storage unit 73, and the third hydrogen tank 73c of the hydrogen storage unit 73 is detachably held will be described.

However, the second hydrogen tank 73b may be filled with hydrogen, hydrogen may be discharged from the third hydrogen tank 73c, and the first hydrogen tank 73a may be detachably held.

Similarly, the third hydrogen tank 73c may be filled with hydrogen, hydrogen may be discharged from the first hydrogen tank 73a, and the second hydrogen tank 73b may be detachably held.

When filling the first hydrogen tank 73a with hydrogen, the control unit 60 opens an inlet valve (the 01-th valve B01) of the first hydrogen tank 73a and a valve (the 17-th valve B17) of a first tank 76a of a buffer tank 76, and closes an outlet valve (the 02-th valve B02). In addition, the control unit 60 opens a cold water supply valve (the 08-th valve B08 and the 14-th valve B14) of a first holding device 74a and closes a hot water supply valve (the 07-th valve B07) of the first holding device 74a. In addition, the control unit 60 turns off a locking mechanism (the first locking mechanism 74a1) of the first holding device 74a so that the first hydrogen tank 73a cannot be removed from the first holding device 74a.

When discharging hydrogen from the second hydrogen tank 73b, the control unit 60 closes an inlet valve (the 03-th valve B03) of the second hydrogen tank 73b and opens an outlet valve (the 04-th valve B04) and a valve (the 18-th valve B18) of a second tank 76b of the buffer tank 76. In addition, the control unit 60 closes a cold water supply valve (the 10-th valve B10) of a second holding device 74b and opens a hot water supply valve (the 09-th valve B09 and the 13-th valve B13) of the second holding device 74b. In addition, the control unit 60 turns off a locking mechanism (the second locking mechanism 74b1) of the second holding device 74b so that the second hydrogen tank 73b cannot be removed from the second holding device 74b.

When the third hydrogen tank 73c is detachably held by a third holding device 74c, the control unit 60 closes an inlet valve (the 05-th valve B05) and an outlet valve (the 06-th valve B06) of the third hydrogen tank 73c. In addition, the control unit 60 closes a cold water supply valve (the 12-th valve B12) and a hot water supply valve (the 11-th valve B11) of the third holding device 74c. In addition, the control unit 60 turns on a locking mechanism (the third locking mechanism 74cl) of the third holding device 74c so that the third hydrogen tank 73c cannot be removed from the third holding device 74c.

The control unit 60 determines whether or not the hydrogen filling rate rh of the first hydrogen tank 73a being filled with hydrogen is equal to or higher than the hydrogen filling rate threshold thrh based on the information from a first detection device 75a of the detection unit 75 of the hydrogen supply unit 70.

In a case where the hydrogen filling rate rh is equal to or higher than the hydrogen filling rate threshold thrh, the control unit 60 closes the valve (the 01-th valve B01) to stop supply of hydrogen to the first hydrogen tank 73a. The control unit 60 also closes the valve (the 08-th valve B08 and the 14-th valve B14) to stop supply of the cooling water to the first hydrogen tank 73a.

The control unit 60 controls the valve of the guide path in such a way that the hot air is supplied to the second hydrogen tank 73b via the guide path 92.

In addition, the control unit 60 controls the valve of the guide path in such a way that the hot air is not supplied to the first hydrogen tank 73a and the third hydrogen tank 73c via the guide path 92.

Specifically, the 23-th valve B23 and the 25-th valve B25 are opened, and the 24-th valve B24 and the 26-th valve B26 are closed.

### (Hydrogen Supply Unit 70)

The hydrogen supply unit 70 includes the hydrogen generation unit 71, a water supply unit 72, the hydrogen storage unit 73, a holding unit 74, the detection unit 75, the buffer tank 76, a high-pressure hydrogen cylinder 77, a depressurization adjustment unit 78, and a gas-liquid separator 79.

### (Hydrogen Generation Unit 71)

The hydrogen generation unit 71 performs electrolysis of an electrolyte such as water to generate hydrogen, and stores the hydrogen in the hydrogen storage unit 73.

Water generated by the second DC power generation device 12 may also be used as the electrolyte.

The hydrogen generation unit 71 includes a dehumidifier that dehumidifies generated hydrogen.

In the present embodiment, an example in which hydrogen generated by the hydrogen generation unit 71 is supplied to the second DC power generation device 12 via the hydrogen storage unit 73 will be described. However, hydrogen generated by the hydrogen generation unit 71 may also be supplied to an external device.

### (Water Supply Unit 72)

The water supply unit 72 includes a first water supply device 72a and a second water supply device 72b.

### (First Water Supply Device 72a)

The first water supply device 72a includes a first water intake unit 72a1.

The first water intake unit 72a1 takes in an electrolyte from the outside, and supplies the electrolyte to the hydrogen generation unit 71.

### (Second Water Supply Device 72b)

The second water supply device 72b includes a second water intake unit 72b1, the water heater 72b2, a hot water tank 72b3, and a cold water tank 72b4.

The second water intake unit 72b1 takes in water from the outside.

A part of the taken-in water is stored in the hot water tank 72b3 in a heated state via the water heater 72b2.

The remainder of the taken-in water is stored in the cold water tank 72b4 in an unheated state.

The water heater 72b2 includes a solar water heater or the like, and heats a part of the water taken in by the second water intake unit 72b1. The water heater 72b2 may be a water heater based on thermal power such as gas.

The hot water tank 72b3 stores hot water. The hot water is used to heat the hydrogen tank which discharges hydrogen.

The cold water tank 72b4 stores cold water. The cold water is used to cool the hydrogen tank which fills hydrogen.

### (Hydrogen Storage Unit 73)

The hydrogen storage unit 73 includes the first to third hydrogen tanks 73a to 73c.

Each of the first to third hydrogen tanks 73a to 73c holds the hydrogen storage alloy AM therein and stores hydrogen by absorption.

The first hydrogen tank 73a is detachably held by the first holding device 74a of the holding unit 74.

The second hydrogen tank 73b is detachably held by the second holding device 74b of the holding unit 74.

The third hydrogen tank 73c is detachably held by the third holding device 74c of the holding unit 74.

Each of the first to third hydrogen tanks 73a to 73c is made of a resin having radio wave permeability.

A first transmission unit 75a1 and a first communication unit 75a2 of the first detection device 75a described below are attached to an outer wall of the first hydrogen tank 73a.

A second transmission unit 75b1 and a second communication unit 75b2 of a second detection device 75b described below are attached to an outer wall of the second hydrogen tank 73b.

A third transmission unit 75c1 and a third communication unit 75c2 of a third detection device 75c described below are attached to an outer wall of the third hydrogen tank 73c.

However, the first detection device 75a may be provided inside the first hydrogen tank 73a. In this case, the first hydrogen tank 73a may be made of metal.

Similarly, the second detection device 75b may be provided inside the second hydrogen tank 73b. In this case, the second hydrogen tank 73b may be made of metal.

Similarly, the third detection device 75c may be provided inside the third hydrogen tank 73c. In this case, the third hydrogen tank 73c may be made of metal.

Hydrogen stored in the first to third hydrogen tanks 73a to 73c is supplied to the second DC power generation device 12.

While hydrogen is absorbed in one of the first to third hydrogen tanks 73a to 73c, hydrogen is discharged from one of the remaining first to third hydrogen tanks 73a to 73c, and the other remaining tank is brought into a removable state without performing any of hydrogen storage and hydrogen discharge.

The hydrogen tank removed from the holding device may be used in another external device.

### (Holding Unit 74)

The holding unit 74 includes the first to third holding devices 74a to 74c.

### (First Holding Device 74a)

The first holding device 74a heats the first hydrogen tank 73a by using the hot water of the hot water tank 72b3 or cools the first hydrogen tank 73a by using the cold water of the cold water tank 72b4.

When storing hydrogen, the first holding device 74a cools the first hydrogen tank 73a by using the cold water of the cold water tank 72b4.

The first holding device 74a includes the first locking mechanism 74a1.

The first locking mechanism 74a1 brings the first hydrogen tank 73a held by the first holding device 74a into a removable state when in an on state (energized state), and brings the first hydrogen tank 73a held by the first holding device 74a into an unremovable state when in an off state (non-energized state).

The on/off state of the first locking mechanism 74a1 desirably interacts with an open/close state of a valve (01-th valve B01) between the hydrogen generation unit 71 and the first hydrogen tank 73a and an open/close state of a valve (02-th valve B02) between the second DC power generation device 12 and the first hydrogen tank 73a.

The first locking mechanism 74a1 is turned on when both the valve (01-th valve B01) between the hydrogen generation unit 71 and the first hydrogen tank 73a and the valve (02-th valve B02) between the second DC power generation device 12 and the first hydrogen tank 73a are closed.

When the first locking mechanism 74a1 is turned on, both the valve (01-th valve B01) between the hydrogen generation unit 71 and the first hydrogen tank 73a and the valve (02-th valve B02) between the second DC power generation device 12 and the first hydrogen tank 73a are closed.

### (Second Holding Device 74b)

The second holding device 74b heats the second hydrogen tank 73b by using the hot water of the hot water tank 72b3 or cools the second hydrogen tank 73b by using the cold water of the cold water tank 72b4.

When storing hydrogen, the second holding device 74b cools the second hydrogen tank 73b by using the cold water of the cold water tank 72b4.

The second holding device 74b includes the second locking mechanism 74b1.

The second locking mechanism 74b1 brings the second hydrogen tank 73b held by the second holding device 74b in to a removable state when in an on state (energized state), and brings the second hydrogen tank 73b held by the second holding device 74b into an unremovable state when in an off state (non-energized state).

The on/off state of the second locking mechanism 74b1 desirably interacts with an open/close state of a valve (03-th valve B03) between the hydrogen generation unit 71 and the second hydrogen tank 73b and an open/close state of a valve (04-th valve B04) between the second DC power generation device 12 and the second hydrogen tank 73b.

The second locking mechanism 74b1 is turned on when both the valve (03-th valve B03) between the hydrogen generation unit 71 and the second hydrogen tank 73b and the valve (04-th valve B04) between the second DC power generation device 12 and the second hydrogen tank 73b are closed.

When the second locking mechanism 74b1 is turned on, both the valve (03-th valve B03) between the hydrogen generation unit 71 and the second hydrogen tank 73b and the valve (04-th valve B04) between the second DC power generation device 12 and the second hydrogen tank 73b are closed.

### (Third Holding Device 74c)

The third holding device 74c heats the third hydrogen tank 73c by using the hot water of the hot water tank 72b3 or cools the third hydrogen tank 73c by using the cold water of the cold water tank 72b4.

When storing hydrogen, the third holding device 74c cools the third hydrogen tank 73c by using the cold water of the cold water tank 72b4.

The third holding device 74c includes the third locking mechanism 74c1.

The third locking mechanism 74c1 brings the third hydrogen tank 73c held by the third holding device 74c into a removable state when in an on state (energized state), and brings the third hydrogen tank 73c held by the third holding device 74c into an unremovable state when in an off state (non-energized state).

The on/off state of the third locking mechanism 74c1 desirably interacts with an open/close state of a valve (05-th valve B05) between the hydrogen generation unit 71 and the third hydrogen tank 73c and an open/close state of a valve (06-th valve B06) between the second DC power generation device 12 and the third hydrogen tank 73c.

The third locking mechanism 74c1 is turned on when both the valve (05-th valve B05) between the hydrogen generation unit 71 and the third hydrogen tank 73c and the valve (06-th valve B06) between the second DC power generation device 12 and the third hydrogen tank 73c are closed.

When the third locking mechanism 74c1 is turned on, both the valve (05-th valve B05) between the hydrogen generation unit 71 and the third hydrogen tank 73c and the valve (06-th valve B06) between the second DC power generation device 12 and the third hydrogen tank 73c are closed.

### (Detection Unit 75)

The detection unit 75 includes the first to third detection devices 75a to 75c.

### (First Detection Device 75a)

The first detection device 75a is detachably attached to the first hydrogen tank 73a.

The first detection device 75a includes the first transmission unit 75a1 and the first communication unit 75a2.

The first detection device 75a is attached to the first hydrogen tank 73a in a positional relationship in which the first transmission unit 75a1 and the first communication unit 75a2 sandwich the hydrogen storage alloy AM disposed inside the first hydrogen tank 73a.

The first transmission unit 75a1 emits radio waves having a first frequency f1, and the first communication unit 75a2 receives radio waves having the first frequency f1.

The first communication unit 75a2 transmits, to the control unit 60, information regarding a radio wave intensity of the radio waves having the first frequency f1 or information regarding a signal waveform of received radio waves.

Signal transmission from the first communication unit 75a2 to the control unit 60 may be wireless or wired transmission.

Wireless communication means between the first transmission unit 75a1 and the first communication unit 75a2 is an RF tag communication method. However, said wireless communication is not limited to the RF tag communication method, and for example, the wireless communication means may be wireless communication means that transmits its own identification information to the outside while said wireless communication means is turned on, such as IEEE 802.15.1 (Bluetooth (registered trademark)) or IEEE 802.11 (wireless LAN).

The wireless communication means of wireless communication performed between the first communication unit 75a2 and the control unit 60 is wireless communication means that transmits its own identification information to the outside while said wireless communication means is turned on, such as IEEE 802.15.1 (Bluetooth (registered trademark)) or IEEE 802.11 (wireless LAN).

### (Second Detection Device 75b)

The second detection device 75b is detachably attached to the second hydrogen tank 73b.

The second detection device 75b includes the second transmission unit 75b1 and the second communication unit 75b2.

The second detection device 75b is attached to the second hydrogen tank 73b in a positional relationship in which the second transmission unit 75b1 and the second communication unit 75b2 sandwich the hydrogen storage alloy AM disposed inside the second hydrogen tank 73b.

The second transmission unit 75b1 emits radio waves having a second frequency f2, and the second communication unit 75b2 receives radio waves having the second frequency f2.

The second communication unit 75b2 transmits, to the control unit 60, information regarding a radio wave intensity of the radio waves having the second frequency f2 or information regarding a signal waveform of received radio waves.

Signal transmission from the second communication unit 75b2 to the control unit 60 may be wireless or wired transmission.

Wireless communication means between the second transmission unit 75b1 and the second communication unit 75b2 is an RF tag communication method. However, said wireless communication is not limited to the RF tag communication method, and for example, the wireless communication means may be wireless communication means that transmits its own identification information to the outside while said wireless communication means is turned on, such as IEEE 802.15.1 (Bluetooth (registered trademark)) or IEEE 802.11 (wireless LAN).

The wireless communication means of wireless communication performed between the second communication unit 75b2 and the control unit 60 is wireless communication means that transmits its own identification information to the outside while said wireless communication means is turned on, such as IEEE 802.15.1 (Bluetooth (registered trademark)) or IEEE 802.11 (wireless LAN).

### (Third Detection Device 75c)

The third detection device 75c is detachably attached to the third hydrogen tank 73c.

The third detection device 75c includes the third transmission unit 75c1 and the third communication unit 75c2.

The third detection device 75c is attached to the third hydrogen tank 73c in a positional relationship in which the third transmission unit 75c1 and the third communication unit 75c2 sandwich the hydrogen storage alloy AM disposed inside the third hydrogen tank 73c.

The third transmission unit 75c1 emits radio waves having a third frequency f3, and the third communication unit 75c2 receives radio waves having the third frequency f3.

The third communication unit 75c2 transmits, to the control unit 60, information regarding a radio wave intensity of the radio waves having the third frequency f3 or information regarding a signal waveform of received radio waves.

Signal transmission from the third communication unit 75c2 to the control unit 60 may be wireless or wired transmission.

Wireless communication means between the third transmission unit 75c1 and the third communication unit 75c2 is an RF tag communication method. However, said wireless communication is not limited to the RF tag communication method, and for example, the wireless communication means may be wireless communication means that transmits its own identification information to the outside while said wireless communication means is turned on, such as IEEE 802.15.1 (Bluetooth (registered trademark)) or IEEE 802.11 (wireless LAN).

The wireless communication means of wireless communication performed between the third communication unit 75c2 and the control unit 60 is wireless communication means that transmits its own identification information to the outside while said wireless communication means is turned on, such as IEEE 802.15.1 (Bluetooth (registered trademark)) or IEEE 802.11 (wireless LAN).

The first frequency f1, the second frequency f2, and the third frequency f3 may be the same frequency, but are desirably different frequencies in order to prevent malfunction.

### (Buffer Tank 76)

The buffer tank 76 includes the first tank 76a and the second tank 76b.

The first tank 76a temporarily stores hydrogen when the hydrogen storage unit 73 is filled with hydrogen from the hydrogen generation unit 71.

The second tank 76b temporarily stores hydrogen when the second DC power generation device 12 is filled with hydrogen from the hydrogen storage unit 73.

### (High-Pressure Hydrogen Cylinder 77)

The high-pressure hydrogen cylinder 77 is used for emergency in a case where hydrogen filled in the hydrogen storage unit 73 is not sufficient.

### (Depressurization Adjustment Unit 78)

The depressurization adjustment unit 78 includes a first depressurization adjustment device 78a and a second depressurization adjustment device 78b.

The first depressurization adjustment device 78a adjusts a pressure of hydrogen from the high-pressure hydrogen cylinder 77.

The second depressurization adjustment device 78b adjusts a pressure of hydrogen supplied to the second DC power generation device 12 such as the first hydrogen tank 73a.

### (Gas-Liquid Separator 79)

The gas-liquid separator 79 separates a liquid of a substance containing hydrogen discharged from the first hydrogen tank 73a or the like from a gas.

### (Heat Transfer Unit 90)

The heat transfer unit 90 includes the fan 91 and the guide path 92.

The fan 91 supplies the cooling air to a heat generating region of the second DC power generation device 12.

The guide path 92 includes a path for guiding the cooling air from the fan 91 to the heat generating region of the second DC power generation device 12, and a path for guiding said hot air heated in the heat generating region to the water heater 72b2, the first hydrogen tank 73a, the second hydrogen tank 73b, and the third hydrogen tank 73c.

The guide path 92 may guide the hot air to a hot water pipe P2.

(01-th switch S01)

The 01-th switch S01 is provided between the first DC power generation device 11 and the first conversion device 31.

The 01-th switch S01 performs on/off control of electric power supply from the first DC power generation device 11 to the first conversion device 31.

### (02-th Switch S02)

The 02-th switch S02 is provided between the first conversion device 31 and the second electric power storage device 52.

The 02-th switch S02 performs on/off control of electric power supply from the first DC power generation device 11 to the second electric power storage device 52 via the first conversion device 31.

### (03-th Switch S03)

The 03-th switch S03 is provided between the first conversion device 31 and the load 100.

The 03-th switch S03 performs on/off control of electric power supply from the first DC power generation device 11 to the load 100 via the first conversion device 31.

### (04-th Switch S04)

The 04-th switch S04 is provided between the first AC power generation device 21 and the fourth conversion device 34.

The 04-th switch S04 performs on/off control of electric power supply from the first AC power generation device 21 to the fourth conversion device 34.

### (05-th Switch S05)

The 05-th switch S05 is provided between the fourth conversion device 34 and the hydrogen generation unit 71.

The 05-th switch S05 performs on/off control of electric power supply from the first AC power generation device 21 to the hydrogen generation unit 71 via the fourth conversion device 34.

### (06-th Switch S06)

The 06-th switch S06 is provided between the second DC power generation device 12 and the third conversion device 33.

The 06-th switch S06 performs on/off control of electric power supply from the second DC power generation device 12 to the third conversion device 33.

### (07-th Switch S07)

The 07-th switch S07 is provided between the first electric power storage device 51 and the hydrogen generation unit 71.

The 07-th switch S07 performs on/off control of electric power supply from the first electric power storage device 51 to the hydrogen generation unit 71.

### (08-th Switch S08)

The 08-th switch S08 is provided between the second electric power storage device 52 and the control unit 60.

The 08-th switch S08 performs on/off control of electric power supply from the second electric power storage device 52 to the control unit 60 and the like.

### (09-th Switch S09)

The 09-th switch S09 is provided between the third electric power storage device 53 and the fifth conversion device 35.

The 09-th switch S09 performs on/off control of electric power supply from the third electric power storage device 53 to the fifth conversion device 35.

### (10-th Switch S10)

The 10-th switch S10 is provided between the fifth conversion device 35 and the load 100.

The 10-th switch S10 performs on/off control of electric power supply from the third electric power storage device 53 to the load 100 via the fifth conversion device 35.

Either the 09-th switch S09 or the 10-th switch S10 may be omitted.

### (01-th Valve B01)

The 01-th valve B01 is provided on a hydrogen pipe P1 between the hydrogen generation unit 71 and the first hydrogen tank 73a.

The 01-th valve B01 serves as the inlet valve (first inlet valve) of the first hydrogen tank 73a and performs on/off control of hydrogen supply from the hydrogen generation unit 71 to the first hydrogen tank 73a.

### (02-th Valve B02)

The 02-th valve B02 is provided on the hydrogen pipe P1 between the first hydrogen tank 73a and the second depressurization adjustment device 78b.

The 02-th valve B02 serves as the outlet valve (first outlet valve) of the first hydrogen tank 73a and performs on/off control of hydrogen supply from the first hydrogen tank 73a to the second DC power generation device 12 via the second depressurization adjustment device 78b.

### (03-th Valve B03)

The 03-th valve B03 is provided on the hydrogen pipe P1 between the hydrogen generation unit 71 and the second hydrogen tank 73b.

The 03-th valve B03 serves as the inlet valve (second inlet valve) of the second hydrogen tank 73b and performs on/off control of hydrogen supply from the hydrogen generation unit 71 to the second hydrogen tank 73b.

### (04-th Valve B04)

The 04-th valve B04 is provided on the hydrogen pipe P1 between the second hydrogen tank 73b and the second depressurization adjustment device 78b.

The 04-th valve B04 serves as the outlet valve (second outlet valve) of the second hydrogen tank 73b and performs on/off control of hydrogen supply from the second hydrogen tank 73b to the second DC power generation device 12 via the second depressurization adjustment device 78b.

### (05-th Valve B05)

The 05-th valve B05 is provided on the hydrogen pipe P1 between the hydrogen generation unit 71 and the third hydrogen tank 73c.

The 05-th valve B05 serves as the inlet valve (third inlet valve) of the third hydrogen tank 73c and performs on/off control of hydrogen supply from the hydrogen generation unit 71 to the third hydrogen tank 73c.

### (06-th Valve B06)

The 06-th valve B06 is provided on the hydrogen pipe P1 between the third hydrogen tank 73c and the second depressurization adjustment device 78b.

The 06-th valve B06 serves as the outlet valve (third outlet valve) of the third hydrogen tank 73c and performs on/off control of hydrogen supply from the third hydrogen tank 73c to the second DC power generation device 12 via the second depressurization adjustment device 78b.

### (07-th Valve B07)

The 07-th valve B07 is provided on the hot water pipe P2 between the hot water tank 72b3 and the first holding device 74a and provided closer to the first holding device 74a.

The 07-th valve B07 serves as the hot water supply valve of the first holding device 74a and performs on/off control of hot water supply from the hot water tank 72b3 to the first holding device 74a.

### (08-th Valve B08)

The 08-th valve B08 is provided on a cold water pipe P3 between the cold water tank 72b4 and the first holding device 74a and provided closer to the first holding device 74a.

The 08-th valve B08 serves as the cold water supply valve of the first holding device 74a and performs on/off control of cold water supply from the cold water tank 72b4 to the first holding device 74a.

### (09-th Valve B09)

The 09-th valve B09 is provided on the hot water pipe P2 between the hot water tank 72b3 and the second holding device 74b, and provided closer to the second holding device 74b.

The 09-th valve B09 serves as the hot water supply valve of the second holding device 74b and performs on/off control of hot water supply from the hot water tank 72b3 to the second holding device 74b.

### (10-th Valve B10)

The 10-th valve B10 is provided on the cold water pipe P3 between the cold water tank 72b4 and the second holding device 74b, and provided closer to the second holding device 74b.

The 10-th valve B10 serves as the cold water supply valve of the second holding device 74b and performs on/off control of cold water supply from the cold water tank 72b4 to the second holding device 74b.

### (11-th Valve B11)

The 11-th valve B11 is provided on the hot water pipe P2 between the hot water tank 72b3 and the third holding device 74c, and provided closer to the third holding device 74c.

The 11-th valve B11 serves as the hot water supply valve of the third holding device 74c and performs on/off control of hot water supply from the hot water tank 72b3 to the third holding device 74c.

### (12-th Valve B12)

The 12-th valve B12 is provided on the cold water pipe P3 between the cold water tank 72b4 and the third holding device 74c, and provided closer to the third holding device 74c.

The 12-th valve B12 serves as the cold water supply valve of the third holding device 74c and performs on/off control of cold water supply from the cold water tank 72b4 to the third holding device 74c.

### (13-th Valve B13)

The 13-th valve B13 is provided on the hot water pipe P2 between the hot water tank 72b3 and the first to third holding devices 74a to 74c, and provided closer to the hot water tank 72b3.

The 13-th valve B13 performs on/off control of hot water supply from the hot water tank 72b3 to the first to third holding devices 74a to 74c.

The 13-th valve B13 may be omitted.

### (14-th Valve B14)

The 14-th valve B14 is provided on the cold water pipe P3 between the cold water tank 72b4 and the first to third holding devices 74a to 74c, and provided closer to the cold water tank 72b4.

The 14-th valve B14 performs on/off control of cold water supply from the cold water tank 72b4 to the first to third holding devices 74a to 74c.

The 14-th valve B14 may be omitted.

### (15-th Valve B15)

The 15-th valve B15 is provided on the hot water pipe P2 between the hot water tank 72b3 and a discharge end of the hot water pipe P2, and provided closer to the discharge end.

The 15-th valve B15 performs on/off control of hot water discharge from the hot water tank 72b3.

### (16-th Valve B16)

The 16-th valve B16 is provided on the cold water pipe P3 between the cold water tank 72b4 and a discharge end of the cold water pipe P3, and provided closer to the discharge end.

The 16-th valve B16 performs on/off control of cold water discharge from the cold water tank 72b4.

### (17-th Valve B17)

The 17-th valve B17 is provided on the hydrogen pipe P1 between the hydrogen generation unit 71 and the first tank 76a of the buffer tank 76.

The 17-th valve B17 adjusts the amount of hydrogen supplied from the first tank 76a to the first hydrogen tank 73a and the like.

### (18-th Valve B18)

The 18-th valve B18 is provided on the hydrogen pipe P1 between the second tank 76b of the buffer tank 76 and the second depressurization adjustment device 78b.

The 18-th valve B18 adjusts the amount of hydrogen supplied from the second tank 76b to the second DC power generation device 12.

### (19-th Valve B19)

The 19-th valve B19 is provided on the hydrogen pipe P1 between the first depressurization adjustment device 78a and the second depressurization adjustment device 78b.

The 19-th valve B19 adjusts the amount of hydrogen supplied from the high-pressure hydrogen cylinder 77 to the second DC power generation device 12.

### (20-th Valve B20)

The 20-th valve B20 is provided on the hydrogen pipe P1 between the second depressurization adjustment device 78b and the gas-liquid separator 79.

The 20-th valve B20 adjusts the amount of hydrogen discharged from the first hydrogen tank 73a and the like to the outside.

### (21-th Valve B21)

The 21-th valve B21 is provided on the hydrogen pipe P1 between the second depressurization adjustment device 78b and the second DC power generation device 12.

The 21-th valve B21 adjusts the amount of hydrogen supplied from the first hydrogen tank 73a and the like to the second DC power generation device 12.

### (22-th Valve B22)

The 22-th valve B22 is provided on the hydrogen pipe P1 between the first hydrogen tank 73a and the like and a discharge end of the hydrogen pipe P1.

The 22-th valve B22 is used as a relief valve.

### (23-th Valve B23)

The 23-th valve B23 is provided on the guide path 92 between the second DC power generation device 12 and the water heater 72b2.

The 23-th valve B23 performs on/off control of hot air supply from the heat generating region of the second DC power generation device 12 to the water heater 72b2.

### (24-th Valve B24)

The 24-th valve B24 is provided on the guide path 92 between the second DC power generation device 12 and the first hydrogen tank 73a.

The 24-th valve B24 performs on/off control of hot air supply from the heat generating region of the second DC power generation device 12 to the first hydrogen tank 73a.

### (25-th Valve B25)

The 25-th valve B25 is provided on the guide path 92 between the second DC power generation device 12 and the second hydrogen tank 73b.

The 25-th valve B25 performs on/off control of hot air supply from the heat generating region of the second DC power generation device 12 to the second hydrogen tank 73b.

### (26-th Valve B26)

The 26-th valve B26 is provided on the guide path 92 between the second DC power generation device 12 and the third hydrogen tank 73c.

The 26-th valve B26 performs on/off control of hot air supply from the heat generating region of the second DC power generation device 12 to the third hydrogen tank 73c.

(Effect of Valve Control of Three Hydrogen Tanks) In an electric power supply system that generates electric power based on hydrogen, a hydrogen tank (for example, the first hydrogen tank 73a) that stores hydrogen, a hydrogen tank (for example, the second hydrogen tank 73b) that discharges hydrogen, and a hydrogen tank (for example, the third hydrogen tank 73c) that is removably held by a holding device without performing hydrogen storage and hydrogen discharge are provided.

Therefore, it is possible to simultaneously perform hydrogen storage, hydrogen discharge, and hydrogen tank replacement in the hydrogen tanks, and it is possible to efficiently store and discharge hydrogen.

(Effect of Hydrogen Filling Rate Calculation Based on Radio Wave Intensity or the like)

When the amount of hydrogen absorbed in the hydrogen storage alloy AM changes, the shape and the like of the hydrogen storage alloy AM change. Based on said change, the radio wave intensity that can be received through said hydrogen storage alloy AM changes. Therefore, by disposing a transmission unit and a communication unit (reception device) in a positional relationship in which said hydrogen storage alloy AM is sandwiched, it is possible to acquire information regarding the radio wave intensity that can be received through the hydrogen storage alloy AM, and it is possible to calculate the amount of hydrogen absorbed in said hydrogen storage alloy AM, that is, the hydrogen filling rate of the hydrogen tank containing said hydrogen storage alloy AM based on said information regarding the radio wave intensity.

Hydrogen can be efficiently stored and discharged by supplying hydrogen to a fuel cell (the second DC power generation device 12) for a hydrogen tank having a high hydrogen filling rate rh and receiving hydrogen supplied from the hydrogen generation unit 71 for a hydrogen tank having a low hydrogen filling rate rh.

### (Effect of Transferring Waste Heat of Fuel Cell to Hydrogen Tank)

By transferring heat obtained by the fuel cell (the second DC power generation device 12) to the first hydrogen tank 73a and the like, the hydrogen storage alloy AM can be heated, and hydrogen can be easily released from said hydrogen storage alloy.

(Effect of Transferring Waste Heat of Fuel Cell to Water Heater or the like)

By transferring heat obtained by the fuel cell (the second DC power generation device 12) to the water heater 72b2 or the like, the hydrogen storage alloy AM can be heated, and hydrogen can be easily released from said hydrogen storage alloy AM.

### (Effect of Providing Locking Mechanism)

It is possible to prevent the hydrogen tank from being inadvertently detached from a holding mechanism even when electric power supply is interrupted and a locking mechanism (such as the first locking mechanism 74a1) is turned off.

In addition, said hydrogen tank is brought into a removable state on the condition that both an inlet valve (the 01-th valve B01 or the like) and an outlet valve (the 02-th valve B02 or the like) of said hydrogen tank are closed. Therefore, it is possible to prevent the hydrogen tank from being inadvertently detached from the holding mechanism during filling of hydrogen or discharge of hydrogen.

In the present embodiment, an example in which the heat transfer unit 90 includes the fan 91 and the guide path 92 has been described.

However, means for transferring heat generated by the second DC power generation device 12 to the first hydrogen tank 73a or the like may be implemented by another device such as a heat pump.

In the present embodiment, an example in which the hot water from the second water supply device 72b heats the first hydrogen tank 73a and the like, and the cold water from the second water supply device 72b cools the first hydrogen tank 73a and the like has been described.

However, heating and cooling of the first hydrogen tank 73a and the like may be performed by another device such as a heat pump.

In the present embodiment, an example in which the first hydrogen tank 73a and the like are heated to discharge hydrogen, and the first hydrogen tank 73a and the like are cooled to store hydrogen has been described.

However, hydrogen may be discharged by depressurizing the inside of the first hydrogen tank 73a or the like, and hydrogen may be stored by pressurizing the inside of the first hydrogen tank 73a or the like.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. The accompanying claims and their equivalents are intended to cover these embodiments and modifications thereof as would fall within the scope and gist of the invention.

### REFERENCE SIGNS LIST

1 Electric power supply system
10 DC power supply unit
11 First DC power generation device
12 Second DC power generation device
20 AC power supply unit
21 First AC power generation device
22 Second AC power generation device
30 Conversion unit
31 First conversion device
32 Second conversion device
33 Third conversion device
34 Fourth conversion device
50 Electric power storage unit
51 First electric power storage device
52 Second electric power storage device
53 Third electric power storage device
60 Control unit
70 Hydrogen supply unit
71 Hydrogen generation unit
72 Water supply unit
72a First water supply device
72a1 First water intake unit
72b Second water supply device
72b1 Second water intake unit
72b2 Water heater
72b3 Hot water tank
72b4 Cold water tank
73 Hydrogen storage unit
73a First hydrogen tank
73b Second hydrogen tank
73c Third hydrogen tank
74 Holding unit
74a First holding device
74a1 First locking mechanism
74b Second holding device
74b2 Second locking mechanism
74c Third holding device
74c1 Third locking mechanism
75 Detection unit
75a First detection device
75a1 First transmission unit
75a2 First communication unit
75b Second detection device
75b1 Second transmission unit
75b2 Second communication unit
75c Third detection device
75c1 Third transmission unit
75c2 Third communication unit
76 Buffer tank
76a First tank
76b Second tank
77 High-pressure hydrogen cylinder
78 Depressurization adjustment unit
78a First depressurization adjustment device
78b Second depressurization adjustment device
79 Gas-liquid separator
90 Heat transfer unit
91 Fan
92 Guide path
100 Load
AM Hydrogen storage alloy
B01 to B26 01-th to 26-th valves
P1 Hydrogen pipe
P2 Hot water pipe
P3 Cold water pipe
rh Hydrogen filling rate
S01 to S10 01-th to 10-th switches
thrh Hydrogen filling rate threshold

1. An electric power supply system comprising:
a hydrogen generation unit;
a hydrogen storage unit including a first hydrogen tank, a second hydrogen tank, and a third hydrogen tank that store hydrogen obtained by the hydrogen generation unit;
a holding unit including a first holding device that holds the first hydrogen tank, a second holding device that holds the second hydrogen tank, and a third holding device that holds the third hydrogen tank; and
a fuel cell configured to generate electric power based on hydrogen supplied from the hydrogen storage unit, wherein
each of the first hydrogen tank, the second hydrogen tank, and the third hydrogen tank holds a hydrogen storage alloy therein and stores hydrogen by absorption,
for a hydrogen tank that receives hydrogen supplied from the hydrogen generation unit among the first hydrogen tank, the second hydrogen tank, and the third hydrogen tank, a valve between the hydrogen tank and the hydrogen generation unit is opened, and a valve between the hydrogen tank and the fuel cell is closed during the reception of supplied hydrogen,
for a hydrogen tank that supplies hydrogen to the fuel cell among the first hydrogen tank, the second hydrogen tank, and the third hydrogen tank, a valve between the hydrogen tank and the hydrogen generation unit is closed, and a valve between the hydrogen tank and the fuel cell is opened during the hydrogen supply, and
for a hydrogen tank that does not receive hydrogen supplied from the hydrogen generation unit and does not supply hydrogen to the fuel cell among the first hydrogen tank, the second hydrogen tank, and the third hydrogen tank, a valve between the hydrogen tank and the hydrogen generation unit is closed, a valve between the hydrogen tank and the fuel cell is closed, and the hydrogen tank is removably held by the holding unit.

2. The electric power supply system according to claim 1, wherein
the hydrogen storage unit includes a detection unit including a first detection device that includes a first transmission unit that emits radio waves having a first frequency and a first communication unit that receives the radio waves from the first transmission unit,
the first transmission unit and the first communication unit are disposed in a positional relationship in which the hydrogen storage alloy of the first hydrogen tank is sandwiched, and
the electric power supply system further comprises a control unit configured to calculate a hydrogen filling rate of the first hydrogen tank based on information regarding at least one of a radio wave intensity or a signal waveform of the radio waves obtained from the first transmission unit by the first communication unit.

3. The electric power supply system according to claim 1, wherein
the hydrogen storage unit includes a detection unit including a first detection device that includes a first transmission unit that emits radio waves having a first frequency and a first communication unit that receives the radio waves from the first transmission unit,
the first transmission unit and the first communication unit are disposed in a positional relationship in which the hydrogen storage alloy of the first hydrogen tank is sandwiched, and
the electric power supply system further comprises a control unit configured to open a first inlet valve to supply hydrogen to the first hydrogen tank in a case where a hydrogen filling rate of the first hydrogen tank is lower than a hydrogen filling rate threshold, and close the first inlet valve in a case where the hydrogen filling rate of the first hydrogen tank is equal to or higher than the hydrogen filling rate threshold, based on information regarding at least one of a radio wave intensity or a signal waveform of the radio waves obtained from the first transmission unit by the first communication unit.

4. The electric power supply system according to claim 2 or 3, wherein
the first hydrogen tank is made of a resin having radio wave permeability, and
the first transmission unit and the first communication unit are attached to an outer wall of the first hydrogen tank.

5. The electric power supply system according to claim 1, further comprising:
a heat transfer unit including a fan configured to supply cooling air to the fuel cell, and a guide path configured to guide hot air obtained by heating the cooling air by the fuel cell to the first hydrogen tank to the third tank; and
a control unit configured to control a valve of the guide path in such a way that the hot air is supplied to the hydrogen tank that supplies hydrogen to the fuel cell among the first hydrogen tank, the second hydrogen tank, and the third hydrogen tank, via the guide path.

6. The electric power supply system according to claim 1, further comprising:
a water heater configured to heat cold water;
a hot water pipe configured to supply hot water from the water heater to the first holding device, the second holding device, and the third holding device; and
a heat transfer unit including a fan configured to supply cooling air to the fuel cell, and a guide path configured to guide hot air obtained by heating the cooling air by the fuel cell to at least one of the water heater or the hot water pipe.

7. The electric power supply system according to claim 1, wherein
the hydrogen tank that receives hydrogen supplied from the hydrogen generation unit among the first hydrogen tank, the second hydrogen tank, and the third hydrogen tank is unremovably held by the holding unit during the reception of supplied hydrogen, and
the hydrogen tank that supplies hydrogen to the fuel cell among the first hydrogen tank, the second hydrogen tank, and the third hydrogen tank is unremovably held by the holding unit during the hydrogen supply.

8. The electric power supply system according to claim 7, wherein
the first holding device includes a first locking mechanism that brings the first hydrogen tank into a removable state when in an on state and brings the first hydrogen tank into an unremovable state when in an off state, and
the first locking mechanism is turned on when both a valve between the hydrogen generation unit and the first hydrogen tank and a valve between the fuel cell and the first hydrogen tank are closed.

9. The electric power supply system according to claim 1, further comprising a heat transfer unit configured to transfer heat generated by the fuel cell to the hydrogen tank that supplies to the fuel cell among the first hydrogen tank, the second hydrogen tank, and the third hydrogen tank.
